(19) United States
(12) Patent Application Publication
(10) Pub. No.: US 2021/0034105 A1
(43) Pub. Date: Feb. 4, 2021

(54) LIQUID DISCHARGE APPARATUS, DISPLAY APPARATUS, AND MOBILE DEVICE

(71) Applicant: SEIKO EPSON CORPORATION, Tokyo (JP)

(72) Inventors: Ryohei HORITA, Matsumoto (JP); Ryo HIRABAYASHI, Matsumoto (JP)

(21) Appl. No.: 16/942,824

(22) Filed: Jul. 30, 2020

(30) Foreign Application Priority Data
Aug. 1, 2019 (JP) 2019-142083

(51) Int. Cl. G06F 1/16; B41J 3/36; H01M 8/10; G06F 1/18; B41J 29/00

(52) U.S. Cl. CPC G06F 1/1635; B41J 3/36; H01M 8/10; H01M 2220/30; B41J 29/00; G06F 1/1626; G06F 1/189

(57) ABSTRACT

A liquid discharge apparatus includes a drive signal output circuit configured to output a drive signal, a drive section including a discharge head configured to discharge a liquid in accordance with the drive signal, a solid-state battery configured to supply electric power to the drive signal output circuit, and a housing that includes a first wall section and a second wall section and houses the drive section, the drive signal output circuit, and the solid-state battery. The solid-state battery includes a solid electrolyte and a first electrode, the first wall section has a first surface that is an outer surface of the housing, the second wall section has a second surface that is an outer surface of the housing, an area of the second surface is larger than an area of the first surface, and the electrolyte and the first electrode are stacked along a direction intersecting the second surface.

The present application is based on, and claims priority from JP Application Serial Number 2019-142083, filed Aug. 1, 2019, the disclosure of which is hereby incorporated by reference herein in its entirety.

### BACKGROUND

### 1. Technical Field

The present disclosure relates to a liquid discharge apparatus, a display apparatus, and a mobile device.

### 2. Related Art

Lightweight compact mobile devices that are portable and have a drive element have been proposed. For example, a mobile device is disclosed JP-A-2016-175374. JP-A-2016-175374 discusses a liquid discharge apparatus that is portable and provided with a lithium-ion battery as a battery.

JP-A-2016-175374 suggests the use of all-solid-state batteries, which are safer than known lithium-ion batteries, for the mobile device instead of known lithium-ion batteries. However, because an all-solid-state battery includes a solid electrolyte, if a part of the electrolyte is damaged due to an impact on the mobile device, the performance of the battery may decrease as compared with known lithium-ion batteries that include liquid electrolytes.

### SUMMARY

According to an aspect of the present disclosure, a liquid discharge apparatus includes a drive signal output circuit configured to output a drive signal, a drive section comprising a discharge head configured to discharge a liquid in accordance with the drive signal, a solid-state battery configured to supply electric power to the drive signal output circuit, and a housing that includes a first wall section and a second wall section, and houses the drive section, the drive signal output circuit, and the solid-state battery, in which the solid-state battery includes a solid electrolyte and a first electrode, the first wall section has a first surface that is an outer surface of the housing, the second wall section has a second surface that is an outer surface of the housing, an area of the second surface is larger than an area of the first surface, and the solid electrolyte and the first electrode are stacked along a direction intersecting the second surface.

In the liquid discharge apparatus according to the aspect, the solid electrolyte and the first electrode may be stacked along a direction in which a liquid is discharged from the discharge head.

In the liquid discharge apparatus according the aspect, the solid-state battery may include a second electrode, and the solid electrolyte, the first electrode, and the second electrode may be stacked along a direction intersecting the second surface in the order of the first electrode, the solid electrolyte, and the second electrode.

In the liquid discharge apparatus according to the aspect, the housing may include a third wall section, the third wall section may overlap with at least a part of the second wall section in a direction of a normal to the second surface, and a shortest distance between the sold state battery and the second wall section may be longer than a shortest distance between the solid-state battery and the third wall section.

According to another aspect of the present disclosure, a display apparatus includes a drive signal output circuit configured to output a drive signal, a drive section comprising a display panel configured to operate in accordance with the drive signal to display an image, a solid-state battery configured to supply electric power to the drive signal output circuit, and a housing that houses the drive section, the drive signal output circuit, and the solid-state battery, in which the solid-state battery includes a solid electrolyte and a first electrode, and the solid electrolyte and the first electrode are stacked along a direction intersecting the display panel.

In the display apparatus according to the aspect, the housing may include a first wall section and a second wall section, the first wall section may have a first surface that is an outer surface of the housing, the second wall section may have a second surface that is an outer surface of the housing, an area of the second surface may be larger than an area of the first surface, and the electrolyte and the first electrode may be stacked along a direction intersecting the second surface.

In the display apparatus according the aspect, the solid-state battery may include a second electrode, and the solid electrolyte, the first electrode, and the second electrode may be stacked along a direction intersecting the second surface in the order of the first electrode, the solid electrolyte, and the second electrode.

In the display apparatus according to the aspect, the display panel may overlap with at least a part of the second wall section in a direction of a normal to the second surface, and a shortest distance between the sold state battery and the second wall section may be longer than a shortest distance between the solid-state battery and the display panel.

According to still another aspect of the present disclosure, a mobile device includes a drive signal output circuit configured to output a drive signal, a drive section configured to perform driving in accordance with the drive signal, a solid-state battery configured to supply electric power to the drive signal output circuit, and a housing that includes a first wall section and a second wall section and houses the drive section, the drive signal output circuit, and the solid-state battery, in which the solid-state battery includes a solid electrolyte and a first electrode, the first wall section has a first surface that is an outer surface of the housing, the second wall section has a second surface that is an outer surface of the housing, an area of the second surface is larger than an area of the first surface, and the solid electrolyte and the first electrode are stacked along a direction intersecting the second surface.

In the mobile device according the aspect, the solid-state battery may include a second electrode, and the solid electrolyte, the first electrode, and the second electrode may be stacked along a direction intersecting the second surface in the order of the first electrode, the solid electrolyte, and the second electrode.

In the mobile device according to the aspect, the housing may include a third wall section, the third wall section may overlap with at least a part of the second wall section in a direction of a normal to the second surface, and a shortest distance between the sold state battery and the second wall section may be longer than a shortest distance between the solid-state battery and the third wall section.

### BRIEF DESCRIPTION OF THE DRAWINGS

FIG. 1 illustrates an example functional configuration of a mobile device.

FIG. 2 illustrates a mobile device viewed from a +Y direction.

FIG. 3 illustrates a mobile printer as a mobile device with its cover being opened, the mobile device viewed from a +Y direction.

FIG. 4 illustrates a mobile device viewed from a −Y direction.

FIG. 5 illustrates a cross-sectional structure of a mobile device taken along line V-V in FIG. 3.

FIG. 6 illustrates a structure of a built-in battery.

FIG. 7 illustrates an example functional configuration of a mobile device according to a second embodiment.

FIG. 8 illustrates a mobile device according to the second embodiment viewed from a front side on which a display panel is disposed.

FIG. 9 illustrates a cross-sectional structure of a mobile device according to the second embodiment taken along line VIII-VIII in FIG. 8.

FIG. 10 illustrates a layout of a built-in battery and a drive unit in a mobile device according to the second embodiment viewed from the front side.

### DESCRIPTION OF EXEMPLARY EMBODIMENTS

Hereinafter, embodiments of the present disclosure will be described with reference to the attached drawings. The drawings are used for convenience in description. It is to be understood that the embodiments described below do not necessarily limit the scope of the disclosure described in the claims, and not all of the configurations and structures described in the embodiments are essential for the disclosure.

### 1. First Embodiment

As a mobile device according to the first embodiment, an ink jet printer that is a mobile liquid discharge apparatus for discharging ink to form an image and can be powered by battery will be described. In the description below, the mobile ink jet printer is simply referred to as a mobile printer. Media for image formation by the mobile printer include, for example, plain paper for printing of images and the like, glossy paper for printing of photos and the like, and various recording paper such as postcards.

### 1.1 Functional Configuration of Mobile Printer

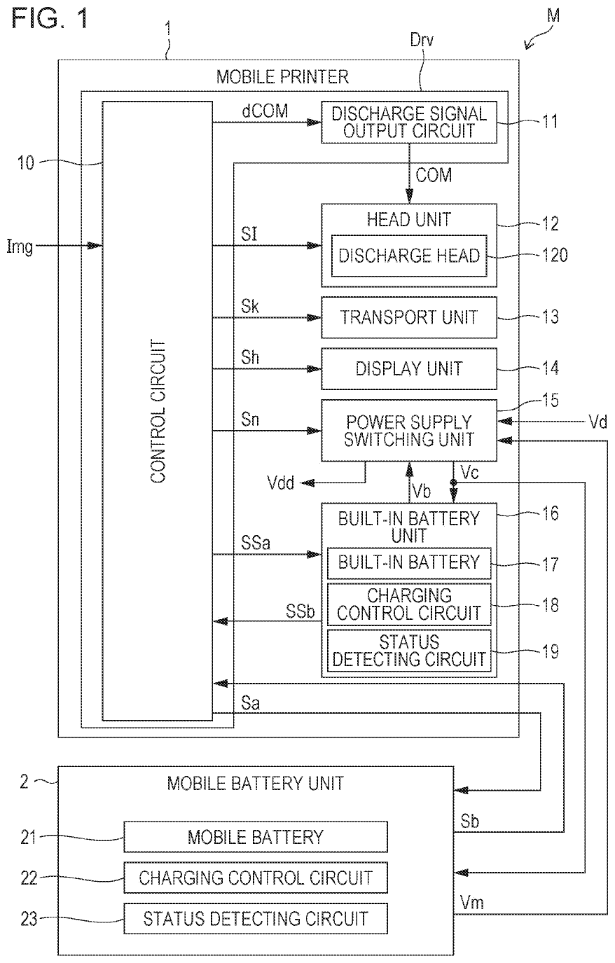

FIG. 1 illustrates an example functional configuration of a mobile device M. As illustrated in FIG. 1, the mobile device M according to the first embodiment includes a mobile printer 1 and a mobile battery unit 2.

The mobile printer 1 includes a control circuit 10, a discharge signal output circuit 11, a head unit 12, a transport unit 13, a display unit 14, a power supply switching unit 15, and a built-in battery unit 16.

The control circuit 10 generates various control signals based on an image information Img that is input from the outside, and outputs the signals to control the operation of various components in the mobile printer 1. The control circuit 10 includes, for example, a central processing unit (CPU). The control circuit 10 may include, instead of the CPU, or in addition to the CPU, at least one of a digital signal processor (DSP), an application specific integrated circuit (ASIC), a programmable logic device (PLD), and a field programmable gate array (FPGA).

The control circuit 10 generates a waveform-defining signal dCOM that is a digital signal for defining a waveform of a discharge signal COM to be output from the discharge signal output circuit 11, and outputs the signal to the discharge signal output circuit 11. The discharge signal output circuit 11 converts the digital waveform-defining signal dCOM into an analog signal, and performs class-D amplification to the converted analog signal to generate a discharge signal COM. More specifically, the waveform-defining signal dCOM is a digital signal for defining a waveform of a discharge signal COM, and the discharge signal output circuit 11 performs class-D amplification to the waveform defined by the waveform-defining signal dCOM to generate a discharge signal COM that has a predetermined voltage value, and outputs the discharge signal COM to the head unit 12. The waveform-defining signal dCOM may be any signal for defining a waveform of a discharge signal COM, and may be an analog signal. The discharge signal output circuit 11 amplifies a waveform defined by a waveform-defining signal dCOM to a predetermined voltage value, and may comprise a class-A amplifier circuit, a class-B amplifier circuit, a class-AB amplifier circuit, or the like.

The control circuit 10 generates a discharge control signal SI for controlling discharging of a liquid from a liquid discharge section (not illustrated) in a discharge head 120 in the head unit 12, and outputs the discharge control signal SI to the head unit 12. The liquid discharge section in the discharge head 120 has nozzles and drive elements for discharging a liquid from the nozzles, such as piezoelectric elements. The drive elements are driven in response to the supply of a discharge signal COM. The nozzles discharge the liquid of an amount corresponding to the driving of the drive elements. The discharge head 120 controls the supply of the discharge signal COM to the drive elements in accordance with a discharge control signal SI that is input. By the control, a liquid of a predetermined amount is discharged at a predetermined time from the nozzles in the liquid discharge section in the discharge head 120.

The control circuit 10 generates a transport control signal Sk for controlling the transport unit 13, and outputs the transport control signal Sk to the transport unit 13. The transport unit 13 transports a medium in a predetermined transport direction. In accordance with the transport control signal Sk, the discharge head 120 discharges a liquid of a predetermined amount at a predetermined time in accordance with a discharge control signal SI in synchronization with the medium transport by the transport unit 13. By the operation, the liquid is discharged at desired positions on the medium, and thereby a desired image is formed on the medium.

The control circuit 10 generates a display control signal Sh for controlling displaying of various kinds of information in the display unit 14, and outputs the display control signal Sh to the display unit 14. In accordance with the display control signal Sh, the display unit 14 displays various kinds of information such as operation information and status information about the mobile device M. The display informs the user of various kinds of information including the operation and status of the mobile device M.

The control circuit 10 generates a control signal SSa for controlling the built-in battery unit 16, and outputs the control signal SSa to the built-in battery unit 16. To the control circuit 10, a status signal SSb is input from the built-in battery unit 16. The built-in battery unit 16 includes a built-in battery 17, a charging control circuit 18, and a status detecting circuit 19. The built-in battery 17 outputs a voltage Vb for driving the mobile device M. The charging control circuit 18 controls charging of the built-in battery 17. The status detecting circuit 19 detects a status of the built-in battery 17, generates a status signal SSb indicating the status, and outputs the signal.

The status detecting circuit 19 detects, for example, a temperature or a voltage of the built-in battery 17 as a status of the built-in battery 17. The status detecting circuit 19 generates a status signal SSb that indicates a status of the built-in battery 17, for example, a temperature or a voltage, and outputs the status signal SSb to the control circuit 10. Based on the input status signal SSb, the control circuit 10 generates a control signal SSa that indicates whether or not to perform charging of the built-in battery 17, and outputs the control signal SSa to the charging control circuit 18. Based on the control signal SSa, the charging control circuit 18 switches whether or not to charge the built-in battery 17.

The control circuit 10 generates a control signal Sa for controlling the mobile battery unit 2, and outputs the control signal Sa to the mobile battery unit 2. To the control circuit 10, a status signal Sb is input from the mobile battery unit 2. The mobile battery unit 2 includes a mobile battery 21, a charging control circuit 22, and a status detecting circuit 23. The mobile battery 21 outputs a voltage Vm for driving the mobile device M. The charging control circuit 22 controls charging of the mobile battery 21. The status detecting circuit 23 detects a status of the mobile battery 21, and outputs a status signal Sb that indicates the status.

The status detecting circuit 23 outputs a status signal Sb that indicates that the mobile battery unit 2 is attached to the mobile printer 1 and thereby the mobile battery 21 is attached and electric power can be supplied to the mobile printer 1. The status detecting circuit 23 detects, for example, a temperature or a voltage of the mobile battery 21 as a status of the mobile battery 21. The status detecting circuit 23 generates a status signal Sb that indicates, for example, a temperature or a voltage of the mobile battery 21, and outputs the status signal Sb to the control circuit 10. Based on the input status signal Sb, the control circuit 10 determines whether the mobile battery 21 is attached, and when the mobile battery 21 is attached, outputs a control signal Sa that indicates whether or not to perform charging of the mobile battery 21 to the charging control circuit 22. Based on the control signal Sa, the charging control circuit 22 switches whether or not to charge the mobile battery 21.

To the power supply switching unit 15, a voltage Vb that is output from the built-in battery unit 16, a voltage Vm that is output from the mobile battery unit 2, and a voltage Vd that is supplied from an alternating current (AC) adapter provided outside the mobile device M are input. The power supply switching unit 15 selects one of the voltages Vb, Vm, and Vd, and supplies the selected voltage as a voltage Vdd that is a power source voltage for the mobile printer 1 to components in the mobile printer 1.

To the power supply switching unit 15, a charge control signal Sn that is generated in the control circuit 10 is input. In accordance with the charge control signal Sn, the power supply switching unit 15 outputs the voltage Vd as a charging voltage Vc for charging the built-in battery 17 and the mobile battery 21 to the built-in battery unit 16 and the mobile battery unit 2.

In the mobile device M, that is, the mobile printer 1, which is an example mobile device M, that has the above-described structure, the discharge signal COM is an example drive signal, and the discharge signal output circuit 11 that outputs the discharge signal COM or a drive unit Dry that includes the discharge signal output circuit 11 and the control circuit 10 is an example drive signal output circuit. The head unit 12 that includes the discharge head 120 that discharges a liquid in accordance with the discharge signal COM is an example drive section in the mobile device M, that is, the mobile printer 1.

The transport control signal Sk and the display control signal Sh are other examples of the drive signal in the mobile device M. The transport unit 13 that performs driving in accordance with the transport control signal Sk and the display unit 14 that performs driving in accordance with the display control signal Sh are other examples of the drive section in the mobile device M. The control circuit 10 that outputs the transport control signal Sk and the display control signal Sh is other example drive signal output circuit in the mobile device M.

The built-in battery 17 that supplies electric power to the mobile device M, that is, the mobile printer 1 that includes the control circuit 10 and the discharge signal output circuit 11 is an all-solid-state battery that contains a solid electrolyte and is an example solid-state battery.

### 1.2 Exterior of Mobile Printer

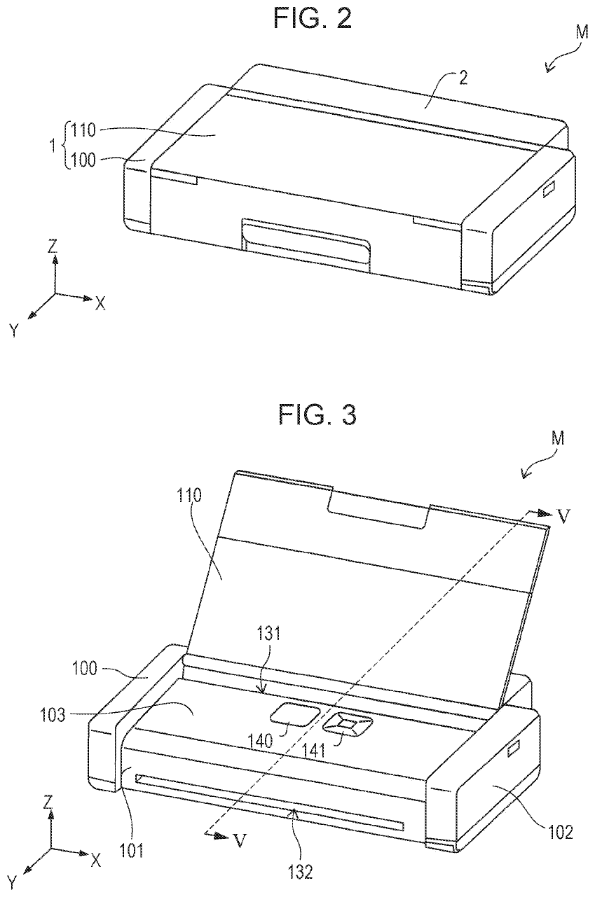

With reference to FIG. 2 to FIG. 4, an external structure of the mobile device M will be described. The following description will be made by using the illustrated X axis, Y axis, and Z axis that are orthogonal to each other. A starting point side on the X axis may be referred to as a “−X direction”, and the opposite side to the starting point may be referred to as a “+X direction”. The “−X direction” and the “+X direction” may be collectively referred to as a “X-axis direction”. Similarly, a starting point side on the Y axis may be referred to as a “−Y direction”, and the opposite side to the starting point may be referred to as a “+Y direction”. The “−Y direction” and the “+Y direction” may be collectively referred to as a “Y-axis direction”. Similarly, a starting point side on the Z axis may be referred to as a “−Z direction”, and the opposite side to the starting point may be referred to as a “+Z direction”. The “−Z direction” and the “+Z direction” may be collectively referred to as a “Z-axis direction”. Although it is assumed that the X axis, the Y axis, and the Z axis are orthogonal to each other in the following description, the components of the mobile device M, that is, the mobile printer 1 may not be orthogonal to each other.

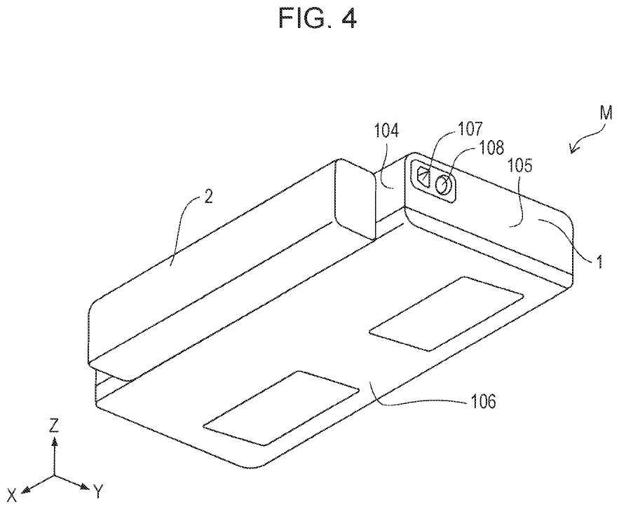

FIG. 2 illustrates the mobile device M viewed from the +Y direction. FIG. 3 illustrates the mobile printer 1 as the mobile device M with its cover 110 being opened, the mobile device M viewed from the +Y direction. FIG. 4 illustrates the mobile device M viewed from the −Y direction.

As illustrated in FIG. 2, the mobile device M includes the mobile printer 1 and the mobile battery unit 2. The mobile battery unit 2 is attached detachably in the −Y direction to the mobile printer 1. The mobile printer 1 includes a housing 100 and a cover 110 that is openably/closably provided in an upper part of the housing.

As illustrated in FIG. 3 and FIG. 4, the housing 100 has wall sections 101, 102, 103, 104, 105, and 106. The wall section 101 is disposed in the +Y direction in the housing 100. The wall section 102 is disposed in the +X direction in the housing 100. The wall section 103 is disposed in the +Z direction in the housing 100. The wall section 104 is disposed in the −Y direction in the housing 100. The wall section 105 is disposed in the −X direction in the housing 100. The wall section 106 is disposed in the −Z direction in the housing 100. More specifically, the wall section 101 and the wall section 104 face each other in the direction along the Y-axis direction, the wall section 102 and the wall section 105 face each other in the direction along the X-axis direction, and the wall section 103 and the wall section 106 face each other in the direction along the Z-axis direction. That is, the six sides of the housing 100 in the mobile printer 1 are surrounded by the wall sections 101 to 106, and the housing 100 has a substantially rectangular parallelepiped shape with an internal space. It is assumed that the mobile printer 1 is used with the wall section 106 faced down. An outer surface of the wall section 106 of the housing 100 corresponds to an installation surface of the mobile printer 1, outer surfaces of the wall sections 101, 102, 104, and 105 of the housing 100 correspond to side surfaces of the mobile printer 1, and a side surface of the wall section 103 of the housing 100 corresponds to a top surface of the mobile printer 1.

On the wall section 103 of the housing 100, as the display unit 14, a display panel 140 and an operation switch 141 are disposed. In accordance with a display control signal Sh, the display panel 140 displays various kinds of information based on an operation and a status of the mobile printer 1. The display panel 140 comprises a display panel such as a liquid crystal panel, an electronic paper panel, or an organic electroluminescence panel. The operation switch 141 receives various user operations. In accordance with operations of the operation switch 141, the mobile device M performs various types of processing. The wall section 103, as the display unit 14, may have a touch panel that is a combination of the display panel 140 and the operation switch 141.

The wall section 103 has a supply slot 131 in the −Y direction for supplying a medium into the housing 100 of the mobile printer 1. The wall section 101 has a discharge slot 132 for discharging a medium that is supplied into the housing 100. A medium supplied from the supply slot 131 into the housing 100 is transported by the transport unit 13 toward the discharge slot 132. The head unit 12 discharges a liquid onto the medium in a transport path, on which the medium is transported inside the housing 100. By the operation, a desired image is formed on the medium discharged from the discharge slot 132.

As illustrated in FIG. 4, the wall section 105 has a direct current (DC) jack 108 into which a DC plug of an AC adapter (not illustrated) can be plugged and a universal serial bus (USB) port 107. The mobile printer 1 is communicatably coupled to an external device such as a personal computer, a digital camera, or the like via a USB cable coupled to the USB port 107. With the configuration, image information Img is supplied to the mobile printer 1. To the mobile printer 1, a voltage Vd is supplied via the DC jack 108. The mobile printer 1 operates by the input voltage Vd as a power source voltage and generates a charging voltage Vc by using the voltage Vd to charge the built-in battery 17 in the built-in battery unit 16 and the mobile battery 21 in the mobile battery unit 2. The mobile battery unit 2 may have a DC jack (not illustrated) for charging the mobile battery 21 when the mobile battery unit 2 is not attached to the mobile printer 1.

### 1.3 Internal Structure of Housing in Mobile Printer

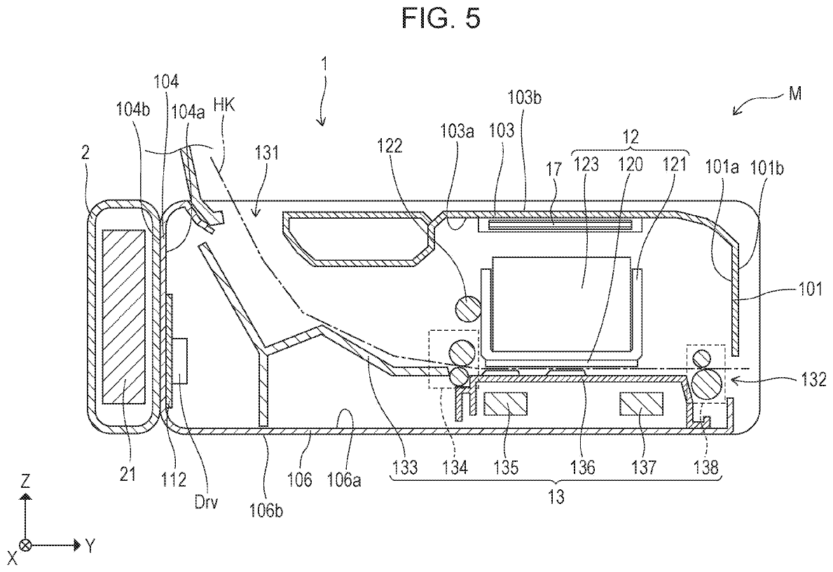

The housing 100 of the above-described mobile printer 1 houses the head unit 12, which is an example of the above-described drive section, a drive unit Dry that includes the control circuit 10 and the discharge signal output circuit 11 and is an example of the discharge signal output circuit, and the built-in battery 17 that is an example solid-state battery. With reference to FIG. 5, a layout of the head unit 12, the drive unit Dry, and the built-in battery 17 inside the housing 100 will be described. In the description below, in the wall section 101, a surface that is an inside of the housing 100 may be referred to as an inner surface 101a, and a surface that is an outside of the housing 100 may be referred to as an outer surface 101b. Similarly, in the respective wall sections 102 to 106, surfaces that are insides in the housing 100 may be referred to as inner surfaces 102a to 106a, and surfaces that are outsides in the housing 100 may be referred to outer surfaces 102b to 106b.

The outer surface 106b of the wall section 106 that is an installation surface of the mobile printer 1 is an example second surface, and the wall section 106 is an example second wall section. One of the outer surface 101b, which is a side surface of the mobile printer 1 and is a part of the wall section 101 having an area smaller than that of the outer surface 106b, the outer surface 102b of the wall section 102, the outer surface 104b of the wall section 104, and the outer surface 105b of the wall section 105 is an example first surface, and corresponding one of the wall sections 101, 102, 104, and 105 is an example first wall section. In the Z-axis direction that is a direction of a normal to the outer surface 106b of the wall section 106, at least a part of the wall section 103 overlaps with the wall section 106, and the wall section 103 is an example third wall section.

FIG. 5 illustrates a cross-sectional structure of the mobile device M taken along line V-V in FIG. 3. FIG. 5 illustrates a serial printer in which the head unit 12 in the mobile printer 1 in the mobile device M has a carriage 121 to which the discharge head 120 is attached, and as the carriage 121 reciprocates along the X-axis direction, the discharge head 120 discharges a liquid to form an image on a medium in synchronization with the reciprocation of the carriage 121.

As illustrated in FIG. 5, the mobile printer 1 includes the head unit 12 and the transport unit 13.

The head unit 12 includes the discharge head 120, the carriage 121, and a liquid storage section 123. The carriage 121 is supported in the −Y direction by a carriage guiding shaft 122 such that the carriage 121 can reciprocate. With the carriage 121 being supported by the carriage guiding shaft 122, the carriage 121 reciprocates along the X axis. The discharge head 120 is attached to a surface of the carriage 121 in the −Z direction. The liquid storage section 123 that stores a liquid to be discharged from the discharge head 120 is mounted on a surface of the carriage 121 in the +Z direction. The liquid storage section 123 and the discharge head 120 are coupled by a liquid flow channel (not illustrated). The liquid stored in the liquid storage section 123 is supplied through the liquid flow channel (not illustrated) to the discharge head 120. The liquid supplied to the discharge head 120 is discharged from the liquid discharge section to form an image onto the image. That is, the head unit 12 includes, in addition to the discharge head 120, the carriage 121, and the liquid storage section 123, the liquid flow channel for supplying a liquid from the liquid storage section 123 to the discharge head 120, and discharges the liquid stored in the liquid storage section 123 to a medium.

The transport unit 13 includes a medium support section 133, a transport roller pair 134, a drive motor 135, a platen 136, a drive motor 137, and a transport roller pair 138. The medium support section 133 and the platen 136 serve as a transport path HK for transporting a medium supplied from the supply slot 131 to the discharge slot 132. A medium supplied to the supply slot 131 is transported from the medium support section 133 to the platen 136 as the transport roller pair 134 is driven. The platen 136 faces the liquid discharge section of the discharge head 120 attached to the carriage 121 in the Z-axis direction. While a medium is supported by the platen 136, the discharge head 120 discharges a liquid along the Z-axis direction, and thereby an image is formed on the medium. That is, the direction along the Z-axis direction is an example direction in which a liquid is discharged from the discharge head 120. After the image formation, the medium is transported toward the discharge slot 132 as the transport roller pair 138 is driven. That is, a medium is transported by the driven transport roller pairs 134 and 138 along the transport path HK comprising the medium support section 133 and the platen 136.

The transport roller pair 134 and the transport roller pair 138 for transporting a medium are controlled by the driving of the drive motor 137. The reciprocation of the carriage 121 is controlled by the driving of the drive motor 135. Accordingly, the control circuit 10 controls the drive motors 135 and 137 in accordance with a transport control signal Sk so as to regulate the medium transport and the reciprocation of the carriage 121 to which the discharge head 120 is attached. By the control, a predetermined amount of liquid is discharged at desired positions on a medium, and a desired image is formed on the medium.

In the −Y direction of the transport path HK, a circuit board 112 is disposed. On the circuit board 112, various circuits are mounted to configure the drive unit Dry. On the circuit board 112, the charging control circuit 18 and the status detecting circuit 19 of the built-in battery unit 16 illustrated in FIG. 1 may be mounted.

The circuit board 112 is attached to the inner surface 104a of the wall section 104 of the housing 100. In other words, at least a part of the drive unit Dry is in contact with the housing 100. As described above, the drive unit Dry outputs signals for operating the components including the head unit 12 and the transport unit 13. Accordingly, the drive unit Dry is likely to consume more electric power than the head unit 12 and the transport unit 13, and thus the drive unit Dry will generate a greater amount of heat than the head unit 12 and the transport unit 13. By disposing the drive unit Dry such that at least a part of the drive unit Dry is in contact with the housing 100, the heat generated in the drive unit Dry can be released through the housing 100, and thus the temperature rise in the drive unit Dry can be suppressed.

The built-in battery 17 is disposed in the +Z direction of the head unit 12, and is attached to the inner surface 103a of the wall section 103 of the housing 100.

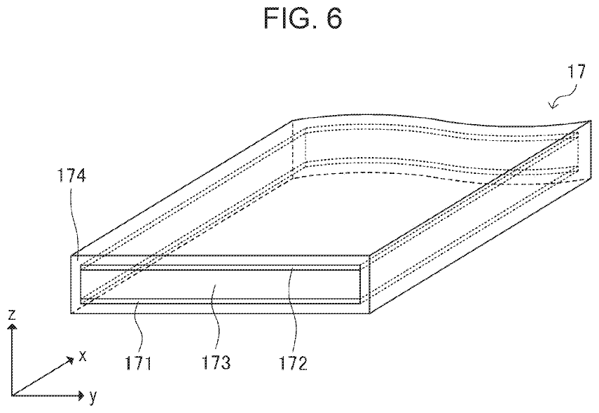

With reference to FIG. 6, a structure of the built-in battery 17 is described. FIG. 6 illustrates an example structure of the built-in battery 17. FIG. 6 illustrates an x axis, a y axis, and a z axis that are orthogonal to each other. Although it is assumed that the x axis, the y axis, and the z axis are orthogonal to each other in the description of FIG. 6, the components of the built-in battery 17 may not be orthogonal to each other.

The built-in battery 17 is a secondary battery that includes electrodes 171 and 172, an electrolyte 173, and a protector 174.

In this embodiment, each of the electrode 171, the electrode 172, and the electrolyte 173 has a flat plate shape and extends along an x-axis-y-axis plane. In a direction along the z axis, the electrode 171, the electrode 172, and the electrolyte 173 are stacked in this order. That is, the electrolyte 173 is disposed between the electrode 171 and the electrode 172. It should be noted that the electrode 171 and the electrolyte 173 and the electrode 172 and the electrolyte 173 may be joined directly or with another material therebetween.

For the electrolyte 173, an inorganic solid electrolyte that contains ceramic or the like is used. One of the electrodes 171 and 172 functions as a positive electrode and the other electrode functions as a negative electrode of the built-in battery 17. The electrons flow through the electrolyte 173, resulting in a predetermined potential difference between the electrode 171 and the electrode 172. The electrolyte 173 also functions as a separator for preventing a short circuit between the electrode 171 and the electrode 172.

The protector 174 covers the stacked electrodes 171 and 172 and the electrolyte 173. The protector 174 prevents an electric shock or the like due to contact between the electrode 171 and the electrode 172 and the structure including the housing 100.

The built-in battery 17 having the above-described structure is attached to the mobile device M, that is, the mobile printer 1 such that the x axis, the y axis, and the z axis in FIG. 6 correspond to the X axis, the Y axis, and the Z axis in FIG. 5. More specifically, the electrodes 171 and 172 and the electrolyte 173 of the built-in battery 17 are stacked in the order of the electrode 171, the electrolyte 173, and the electrode 172 in a direction intersecting the outer surface 106b of the wall section 106, and along the Z-axis direction that is a direction in which a liquid is discharged from the discharge head 120.

The built-in battery 17, which includes the solid electrolyte 173 and the electrodes 171 and 172, and supplies electric power to the mobile device M, that is, the mobile printer 1 that includes the control circuit 10 and the discharge signal output circuit 11, is an example solid-state battery. One of the electrodes 171 and 172 is an example first electrode, and the other electrode is an example second electrode.

### 1.4 Operational Effects

The built-in battery 17 having the above-described structure uses an inorganic solid electrolyte, and thus the built-in battery 17 has lower risk of catching fire and higher safety than batteries that use a liquid electrolyte. Furthermore, since the electrolyte 173 is solid, it has advantages in high thermal stability and a wide operating temperature range.

However, in the built-in battery 17 including the solid electrolyte 173, since the electrolyte 173 is a solid, as compared with batteries that use liquid electrolytes, the impact resistance is low, and thus an impact on a device that is provided with the built-in battery 17 could cause a damage to a part of the solid electrolyte 173, such as cracking or chipping, resulting in decrease in performance in the built-in battery 17. In particular, since the mobile device M, that is, the mobile printer 1 according to the embodiment is a portable device, an unexpected impact may be given to the mobile device M, that is, the mobile printer 1.

To solve the problem, in the mobile device M, that is, the mobile printer 1 according to the embodiment, in the housing 100 in the mobile device M, that is, the mobile printer 1, the built-in battery 17 is disposed such that the electrolyte 173 and the electrodes 171 and 172 are stacked in a direction intersecting the outer surface 106b in the large-area wall section 106. In the stacked electrodes 171 and 172 and the electrolyte 173, the electrode 171 and the electrode 172 function as reinforcements that reinforce the strength of the electrolyte 173. In the housing 100, in the direction intersecting the outer surface 106b of the wall section 106 that has a large area and is likely to receive an impact such as an external stress, the electrolyte 173 and the electrodes 171 and 172 are stacked, and thereby the electrolyte 173 is less likely to be damaged if an external stress such as an impact is applied to the mobile device M, that is, the mobile printer 1.

Furthermore, as illustrated in FIG. 5, it is preferable that the direction in which the electrolyte 173 and the electrodes 171 and 172 are stacked be the Z-axis direction in which a liquid is discharged from the discharge head 120, and the outer surface 106b of the wall section 106 be used as an installation surface for installation of the mobile printer 1.

To the installation surface for installation of the mobile printer 1, impacts such as an external stress are more likely to be applied, as compared to the other walls. In the direction along the direction intersecting the outer surface 106b of the wall section 106, which is the installation surface to which impacts such as an external stress are likely to be applied, the electrolyte 173 and the electrodes 171 and 172 are stacked. With the structure, the electrodes 171 and 172 function as reinforcements, and the occurrence of damages to the electrolyte 173 is further reduced.

It is preferable that in the housing 100, the built-in battery 17 be disposed at a position closer to the wall section 103 than the wall section 106. In other words, it is preferable that a shortest distance between the built-in battery 17 and the wall section 106 be longer than a shortest distance between the built-in battery 17 and the wall section 103. With the built-in battery 17 disposed as described above, if an external stress is applied to the outer surface 106b that is more likely to receive an external stress, the electrolyte 173 and the electrodes 171 and 172 are stacked in the direction along the direction intersecting the inner surface 106a of the wall section 106, and thus the occurrence of damages to the electrolyte 173 can be further reduced.

### 1.5 Modification

The mobile printer 1 in the mobile device M according to the first embodiment is a serial ink jet printer that reciprocates the carriage 121 along the X-axis direction in the housing 100 and discharges a liquid from the discharge head 120 in synchronization with the reciprocation. Alternatively, a line ink jet printer that has a plurality of discharge heads 120 in a direction intersecting a medium transport direction and discharges a liquid from each of the discharge heads 120 as a medium is transported may be used. The mobile device M that includes the mobile printer 1 of such a structure can achieve operational effects similar to those of the mobile device M according to the first embodiment.

Furthermore, in the mobile printer 1 in the mobile device M according to the first embodiment, the liquid storage section 123 for storing a liquid is mounted on the carriage 121 in the housing 100. However, the liquid storage section 123 may be disposed at a predetermined position in the housing 100 other than the carriage. The mobile device M that includes the mobile printer 1 of such a structure can achieve operational effects similar to those of the mobile device M according to the first embodiment.

### 2. Second Embodiment

As a mobile device according to the second embodiment, a smart phone that is a display device that displays various kinds of information on a display panel and can operate by battery will be described.

### 2.1 Functional Configuration of Smart Phone

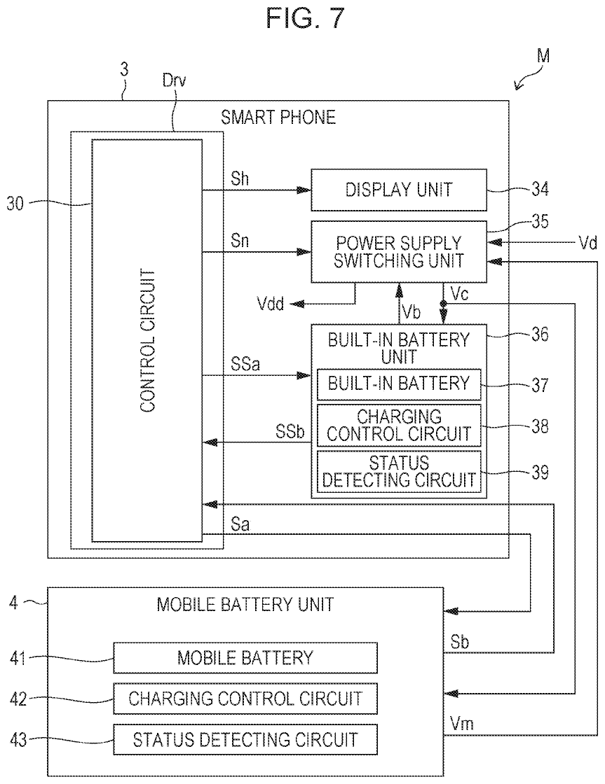

FIG. 7 illustrates an example functional configuration of a mobile device M according to a second embodiment. As illustrated in FIG. 7, the mobile device M according to the second embodiment includes a smart phone 3 and a mobile battery unit 4.

The smart phone 3 includes a control circuit 30, a display unit 34, a power supply switching unit 35, and a built-in battery unit 36.

The control circuit 30 generates various control signals based on information that is input from the outside, and outputs the signals to control the operation of various components in the smart phone 3. The control circuit 30 includes, for example, a CPU. The control circuit 30 may include, instead of the CPU, or in addition to the CPU, at least one of a DSP, an ASIC, a PLD, and a FPGA.

The control circuit 30 generates a display control signal Sh for controlling displaying in the display unit 34, and outputs the display control signal Sh to the display unit 34. In accordance with the display control signal Sh, the display unit 34 displays various kinds of information about the mobile device M. By the display, operation information about the mobile device M and various kinds of information acquired by the mobile device M are provided to a user. The information acquired by the mobile device M includes, for example, acquisition information acquired by the smart phone 3 in the mobile device M via a network line such as the Internet, terminal information such as usage history of the smart phone 3, and status information that indicates a remaining battery level of the smart phone 3 and conditions of the received radio wave.

The control circuit 30 generates a control signal SSa for controlling the built-in battery unit 36, and outputs the control signal SSa to the built-in battery unit 36. To the control circuit 30, a status signal SSb is input from the built-in battery unit 36. The built-in battery unit 36 includes a built-in battery 37, a charging control circuit 38, and a status detecting circuit 39. The built-in battery 37 outputs a voltage Vb for driving the mobile device M. The charging control circuit 38 controls charging of the built-in battery 37. The status detecting circuit 39 detects a status of the built-in battery 37, generates a status signal SSb that indicates the status, and outputs the signal. For the built-in battery 37 according to the embodiment, an all-solid-state battery that includes a solid electrolyte is used.

The status detecting circuit 39 detects, for example, a temperature or a voltage of the built-in battery 37 as a status of the built-in battery 37. The status detecting circuit 39 generates a status signal SSb that indicates a status of the built-in battery 37, for example, a temperature or a voltage, and outputs the status signal SSb to the control circuit 30. Based on the input status signal SSb, the control circuit 30 generates a control signal SSa that indicates whether or not to perform charging of the built-in battery 37, and outputs the control signal SSa to the charging control circuit 38. Based on the control signal SSa, the charging control circuit 38 switches whether or not to charge the built-in battery 37.

The control circuit 30 generates a control signal Sa for controlling the mobile battery unit 4, and outputs the control signal Sa to the mobile battery unit 4. To the control circuit 30, a status signal Sb is input from the mobile battery unit 4. The mobile battery unit 4 includes a mobile battery 41, a charging control circuit 42, and a status detecting circuit 43. The mobile battery 41 outputs a voltage Vm for driving the mobile device M. The charging control circuit 42 controls charging of the mobile battery 41. The status detecting circuit 43 detects a status of the mobile battery 41, and outputs a status signal Sb that indicates the status.

The status detecting circuit 43 outputs a status signal Sb that indicates that the mobile battery unit 4 is attached to the smart phone 3 and thereby the mobile battery 41 can supply electric power to the smart phone 3. The status detecting circuit 43 detects, for example, a temperature or a voltage of the mobile battery 41 as a status of the mobile battery 41. The status detecting circuit 43 generates a status signal Sb that indicates, for example, a temperature or a voltage of the mobile battery 41, and outputs the status signal Sb to the control circuit 30. Based on the input status signal Sb, the control circuit 30 determines whether or not the mobile battery 41 is attached, and when the mobile battery 41 is attached, outputs a control signal Sa that indicates whether or not to perform charging of the mobile battery 41. Based on the control signal Sa, the charging control circuit 42 switches whether or not to charge the mobile battery 41.

To the power supply switching unit 35, a voltage Vb that is output from the built-in battery unit 36, a voltage Vm that is output from the mobile battery unit 4, and a voltage Vd that is supplied from an AC adapter provided outside the mobile device M are input. The power supply switching unit 35 selects one of the voltages Vb, Vm, and Vd, and supplies the selected voltage as a voltage Vdd that is a power source voltage for the smart phone 3 to components in the smart phone 3.

To the power supply switching unit 35, a charge control signal Sn that is generated in the control circuit 30 is input. In accordance with the charge control signal Sn, the power supply switching unit 35 outputs the voltage Vd as a charging voltage Vc for charging the built-in battery 37 and the mobile battery 41 to the built-in battery unit 36 and the mobile battery unit 4.

In the above-described mobile device M, that is, the smart phone 3, which is an example mobile device M, the drive unit Dry that includes the control circuit 30 is an example drive signal output circuit. The display control signal Sh that is output from the control circuit 30 is an example of the drive signal in the mobile device M, that is, the smart phone 3. The display unit 34 that displays various kinds of information in accordance with the display control signal Sh is an example of the drive section in the mobile device M, that is, the smart phone 3. The built-in battery 37 that supplies electric power to the mobile device M, which includes the control circuit 30, and the smart phone 3, which is an example of the mobile device M, is an all-solid-state battery that contains a solid electrolyte and is an example solid-state battery.

### 2.2 Structure of Smart Phone

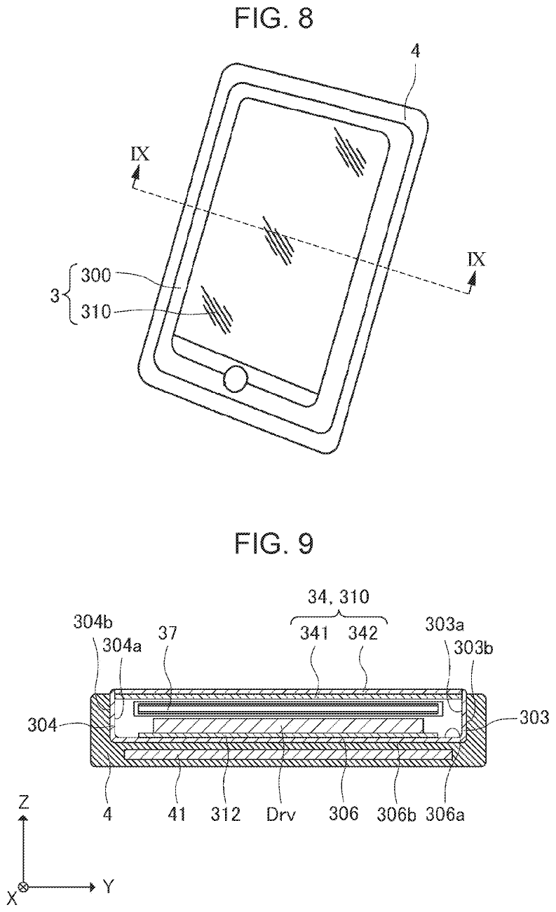

With reference to FIG. 8 to FIG. 10, a structure of the mobile device M that has the smart phone 3 and the mobile battery unit 4 will be described. The following description will be made by using the illustrated X axis, Y axis, and Z axis that are orthogonal to each other. A starting point side on the X axis may be referred to as a “−X direction”, and the opposite side to the starting point may be referred to as a “+X direction”. The “−X direction” and the “+X direction” may be collectively referred to as an “X-axis direction”. Similarly, a starting point side on the Y axis may be referred to as a “−Y direction”, and the opposite side to the starting point may be referred to as a “+Y direction”. The “−Y direction” and the “+Y direction” may be collectively referred to as a “Y-axis direction”. Similarly, a starting point side on the Z axis may be referred to as a “−Z direction”, and the opposite side to the starting point may be referred to as a “+Z direction”. The “−Z direction” and the “+Z direction” may be collectively referred to as a “Z-axis direction”. Although it is assumed that the X axis, the Y axis, and the Z axis are orthogonal to each other in the following description, the components of the mobile device M, that is, the smart phone 3 may not be orthogonal to each other.

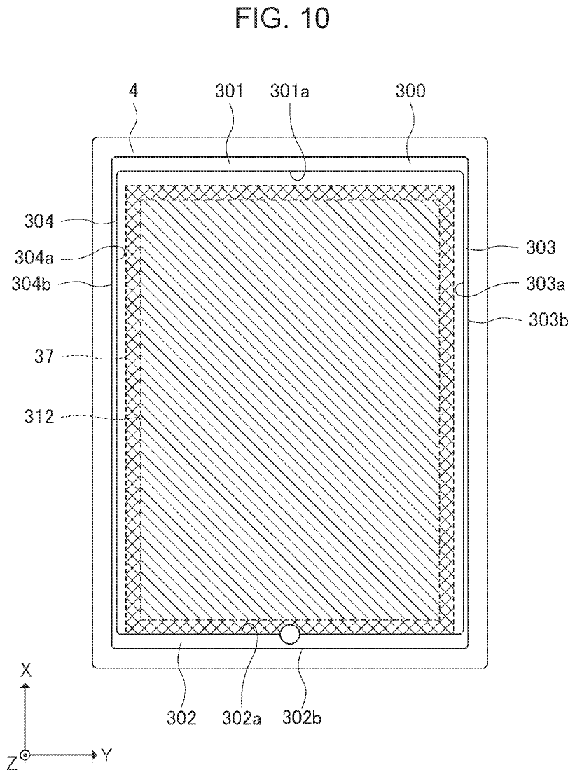

FIG. 8 illustrates the mobile device M according to the second embodiment viewed from a front side on which a display panel 310 is disposed. FIG. 9 illustrates a cross-sectional structure of a mobile device M according to the second embodiment taken along line IX-IX in FIG. 8. FIG. 10 illustrates a layout of the built-in battery 37 and the drive unit Dry in the mobile device M according to the second embodiment viewed from the front side.

As illustrated in FIG. 8, the mobile device M includes the smart phone 3 and the mobile battery unit 4. The mobile battery unit 4 is detachably attached to a rear side of the smart phone 3. The smart phone 3 has a housing 300 and the display panel 310.

As illustrated in FIG. 9 and FIG. 10, the housing 300 has wall sections 301, 302, 303, 304, and 306, and one side is open. The wall section 306 is disposed to face an open surface that is the open side of the housing 300. The wall section 301 is disposed in the +X direction in the housing 300. The wall section 302 is disposed in the −X direction in the housing 300. The wall section 303 is disposed in the +Y direction in the housing 300. The wall section 304 is disposed in the −Y direction in the housing 300. More specifically, the wall section 301 and the wall section 302 face each other in the direction along the X-axis direction, the wall section 303 and the wall section 304 face each other in the direction along the Y-axis direction, and the wall section 306 and the open surface face each other in the direction along the Z-axis direction. In the description below, in the wall section 301, a surface that is an inside of the housing 300 may be referred to as an inner surface 301a, and a surface that is an outside of the housing 300 may be referred to as an outer surface 301b. Similarly, in the respective wall sections 302, 303, 304, and 306, surfaces that are insides of the housing 300 may be referred to as inner surfaces 302a, 303a, 304a, and 306a, and surfaces that are outsides of the housing 300 may be referred to outer surfaces 302b, 303b, 304b, and 306b.

The outer surface 306b of the wall section 306 is an example second surface according to the second embodiment, and the wall section 306 is an example second wall section according to the second embodiment. One of the outer surface 301b that is a part of the wall section 301 having an area smaller than that of the outer surface 306b, the outer surface 302b of the wall section 302, the outer surface 303b of the wall section 303, and the outer surface 304b of the wall section 304 is an example first surface according to the second embodiment, and corresponding one of the wall sections 301, 302, 303, and 304 is an example first wall section according to the second embodiment.

In the housing 300, in the open surface that faces the wall section 306 in a direction along the Z-axis direction, the display panel 310 is disposed. The display panel 310 includes a display section 341 and a sensor section 342 that is stacked on the display section 341. The display section 341 comprises a liquid crystal panel, an electronic paper panel, an organic electroluminescence panel, or the like. The sensor section 342 functions as an operation section that receives a user operation. The sensor section 342 comprises a resistance film sensor, a capacitance sensor, a surface acoustic wave sensor, or the like. That is, the display panel 310 according to the embodiment is a touch panel that is a combination of the display section 341 and the sensor section 342 that functions as an operation switch. The display panel 310 corresponds to the display unit 34 that operates in accordance with a display control signal Sh.

The housing 300 of the smart phone 3 that has the above-described structure houses the display unit 34, which is an example of the above-described drive section, the drive unit Dry, which is an example drive signal output circuit, and the built-in battery 37, which is an example solid-state battery.

More specifically, as illustrated in FIG. 9 and FIG. 10, a circuit board 312 on which the drive unit Dry is mounted is attached to the inner surface 306a of the wall section 306 of the housing 300. In other words, at least a part of the drive unit Dry is in contact with the housing 300. As described above, the drive unit Dry outputs signals for operating the components such as the display unit 34. Accordingly, the drive unit Dry is likely to consume more electric power than the display unit 34, and thus the drive unit Dry will generate a greater amount of heat than the display unit 34. By disposing the drive unit Dry such that at least a part of the drive unit Dry is in contact with the housing 300, the heat generated in the drive unit Dry can be released through the housing 300, and thus the temperature rise due to the heat generated in the drive unit Dry can be suppressed.

The built-in battery 37 has a structure similar to that of the built-in battery 17 according to the first embodiment illustrated in FIG. 6. That is, the built-in battery 37 is a solid-state battery that includes the electrodes 171 and 172 and the solid electrolyte 173, and the electrolyte 173 is disposed between the electrode 171 and the electrode 172. The built-in battery 37 supplies electric power to the drive unit Dry in the mobile device M, that is, the smart phone 3. The built-in battery 37 is disposed between the circuit board 312 and the display panel 310 in the +Z direction of the circuit board 312 such that the electrodes 171 and 172 and the electrolyte 173 are stacked in the order of the electrode 171, the electrolyte 173, and the electrode 172. More specifically, the built-in battery 37 has the electrodes 171 and 172 and the electrolyte 173 that are stacked in the order of the electrode 171, the electrolyte 173, and the electrode 172 in the Z-axis direction that intersects the inner surface 306a of the wall section 306.

As described above, the wall section 306 and the display panel 310 face each other in the Z-axis direction. That is, in the Z-axis direction that is a direction of a normal to the outer surface 306b of the wall section 306, the display panel 310 overlaps with at least a part of the wall section 306. Accordingly, the built-in battery 37 has the electrodes 171 and 172 and the electrolyte 173 that are stacked in the order of the electrode 171, the electrolyte 173, and the electrode 172 in the Z-axis direction that intersects the display surface of the display panel 310.

As illustrated in FIG. 9, the built-in battery 37 is disposed such that a shortest distance between the built-in battery 37 and the wall section 306 is longer than a shortest distance between the built-in battery 37 and the display panel 310.

The mobile device M according to the second embodiment that has the above-described structure, that is, the smart phone can achieve operational effects similar to those of the mobile device M according to the first embodiment, that is, the mobile printer 1.

### 3. Other Embodiments

The mobile device M according to the first embodiment employs the mobile printer 1 as the portable liquid discharge apparatus, and the mobile device M according to the second embodiment employs the smart phone 3 as the display apparatus. However, the mobile device M may be any battery-powered portable device, for example, mobile devices M such as a tablet terminal, a mobile phone, a computer, or a digital audio player. In such a case, operational effects similar to those in the first embodiment or the second embodiment can be achieved.

Although the embodiments and modifications have been described in the above description, the disclosure is not limited to the above-described embodiments and modifications, and various modifications can be made without departing from the scope of the disclosure. For example, the embodiments may be appropriately combined.

The disclosure includes structures and configurations substantially similar to those in the above-described embodiments, for example, structures and configurations that can achieve similar functions, methods, or results, or similar objects and effects. Furthermore, the disclosure includes structures and configurations in which components that are not essential to the structures and configurations described in the embodiments are replaced. Furthermore, the disclosure includes structures and configurations that can achieve operational effects similar to those in the embodiments or structures and configuration that can achieve objects similar to those in the embodiments. Furthermore, the disclosure includes structures and configurations to which known arts are applied.

What is claimed is:

1. A liquid discharge apparatus comprising:
a drive signal output circuit configured to output a drive signal;
a drive section comprising a discharge head configured to discharge a liquid in accordance with the drive signal;
a solid-state battery configured to supply electric power to the drive signal output circuit; and
a housing that includes a first wall section and a second wall section, and houses the drive section, the drive signal output circuit, and the solid-state battery, wherein
the solid-state battery includes a solid electrolyte and a first electrode,
the first wall section has a first surface that is an outer surface of the housing,
the second wall section has a second surface that is an outer surface of the housing,
an area of the second surface is larger than an area of the first surface, and
the solid electrolyte and the first electrode are stacked along a direction intersecting the second surface.

2. The liquid discharge apparatus according to claim 1, wherein the solid electrolyte and the first electrode are stacked along a direction in which a liquid is discharged from the discharge head.

3. The liquid discharge apparatus according claim 1, wherein the solid-state battery includes a second electrode, and
the solid electrolyte, the first electrode, and the second electrode are stacked along a direction intersecting the second surface in the order of the first electrode, the solid electrolyte, and the second electrode.

4. The liquid discharge apparatus according to claim 1, wherein the housing includes a third wall section,
the third wall section overlaps with at least a part of the second wall section in a direction of a normal to the second surface, and
a shortest distance between the sold state battery and the second wall section is longer than a shortest distance between the solid-state battery and the third wall section.

5. A display apparatus comprising:
a drive signal output circuit configured to output a drive signal;
a drive section comprising a display panel configured to operate in accordance with the drive signal to display an image;
a solid-state battery configured to supply electric power to the drive signal output circuit; and
a housing that houses the drive section, the drive signal output circuit, and the solid-state battery, wherein
the solid-state battery includes a solid electrolyte and a first electrode, and
the solid electrolyte and the first electrode are stacked along a direction intersecting the display panel.

6. The display apparatus according to claim 5, wherein the housing includes a first wall section and a second wall section,
the first wall section has a first surface that is an outer surface of the housing,
the second wall section has a second surface that is an outer surface of the housing,
an area of the second surface is larger than an area of the first surface, and
the solid electrolyte and the first electrode are stacked along a direction intersecting the second surface.

7. The display apparatus according claim 6, wherein the solid-state battery includes a second electrode, and
the solid electrolyte, the first electrode, and the second electrode are stacked along a direction intersecting the second surface in the order of the first electrode, the solid electrolyte, and the second electrode.

8. The display apparatus according to claim 6, wherein the display panel overlaps with at least a part of the second wall section in a direction of a normal to the second surface, and
a shortest distance between the sold state battery and the second wall section is longer than a shortest distance between the solid-state battery and the display panel.

9. A mobile device comprising:
a drive signal output circuit configured to output a drive signal;
a drive section configured to perform driving in accordance with the drive signal;
a solid-state battery configured to supply electric power to the drive signal output circuit; and
a housing that includes a first wall section and a second wall section, and houses the drive section, the drive signal output circuit, and the solid-state battery, wherein
the solid-state battery includes a solid electrolyte and a first electrode,
the first wall section has a first surface that is an outer surface of the housing,
the second wall section has a second surface that is an outer surface of the housing,
an area of the second surface is larger than an area of the first surface, and
the solid electrolyte and the first electrode are stacked along a direction intersecting the second surface.

10. The mobile device according claim 9, wherein the solid-state battery includes a second electrode, and
the solid electrolyte, the first electrode, and the second electrode are stacked along a direction intersecting the second surface in the order of the first electrode, the solid electrolyte, and the second electrode.

11. The mobile device according to claim 9, wherein the housing includes a third wall section,
the third wall section overlaps with at least a part of the second wall section in a direction of a normal to the second surface, and
a shortest distance between the sold state battery and the second wall section is longer than a shortest distance between the solid-state battery and the third wall section.
